(19) United States
(12) Patent Application Publication
(10) Pub. No.: US 2023/0393245 A1
(43) Pub. Date: Dec. 7, 2023

(54) INTEGRATED LONG-RANGE NARROW-FOV AND SHORT-RANGE WIDE-FOV SOLID-STATE FLASH LIDAR SYSTEM

(71) Applicant: Sense Photonics, Inc., Durham, NC (US)

(72) Inventors: Hod Finkelstein, Berkeley, CA (US); Anurag GUPTA, San Jose, CA (US)

(21) Appl. No.: 18/249,428

(22) PCT Filed: Oct. 22, 2021
(86) PCT No.: PCT/US2021/056214

§ 371 Date: Apr. 18, 2023

Related U.S. Application Data
(60) Provisional application No. 63/104,726, filed on Oct. 23, 2020.

(51) Int. Cl. G01S 7/481; G01S 17/931; G01S 17/894

(52) U.S. Cl. CPC G01S 7/4816; G01S 7/4815; G01S 17/931; G01S 17/894

(57) ABSTRACT

A Light Detection and Ranging (LIDAR) system includes a lidar detector comprising one or more detector pixels configured to detect light incident thereon, and at least one switchable optical element that is configured to direct the light to the lidar detector. The at least one switchable optical element is configured to be switched between first and second optical characteristics that provide different first and second fields of view, respectively. Related systems and methods of operation are also discussed.

### CLAIM OF PRIORITY

This application claims priority from U.S. Provisional Patent Application Ser. No. 63/104,726, filed Oct. 23, 2020, the disclosure of which is incorporated by reference herein in its entirety.

### FIELD

The present invention relates generally to Light Detection And Ranging (LIDAR; also referred to herein as lidar)-based imaging systems and related methods of operation.

### BACKGROUND

Time of flight (ToF)-based imaging is used in a number of applications including range finding, depth profiling, and 3D imaging (e.g., lidar). Direct time of flight (dToF) measurement includes directly measuring the length of time between emitting radiation by emitter element(s) of the lidar system and sensing the radiation at detector element(s) of the lidar system after reflection from an object or other target, where the reflected radiation may be referred to as an “echo” signal. From this length of time, the distance to the target can be determined. Indirect time of flight (iToF) measurement includes determining the distance to the target by phase modulating the amplitude of the signals emitted by emitter element(s) of the lidar system and measuring phases (e.g., with respect to delay or shift) of the echo signals received at detector element(s) of the lidar system. These phases may be measured with a series of separate measurements or samples.

In automotive or autonomous vehicle applications, long-range lidar may be desirable to detect objects from close ranges (e.g., less than about 1 meter (m)) to long ranges (e.g., 100, 150, 200, 250 m), for example, while driving on freeways. Lidar resolution may be measured by the angular resolution (in the horizontal and vertical axes or directions) and range resolution (with respect to distance from the lidar system). Long-range lidar typically requires fine angular resolution because horizontal (or lateral) and vertical dimensions of an imaged object can be given by:

s=rθ

where s is approximately the horizontal or vertical dimension (X or Y), r is the target range and θ is the horizontal or vertical angular resolution (in radians). For example, at r=200 meters (m), a lidar system with a horizontal angular resolution of 0.1 degree may have a horizontal resolution of 35 cm. At long range, the desired field of view may be relatively narrow. For example a 30 degree or more (e.g., 60 degree) horizontal angular resolution at 200 m may translate (using the same formula) to 209.33 m, which may be sufficient for automotive applications. Conversely, short-range lidar may be used for urban driving where desired ranges are shorter, e.g., 10, 15, 20, 25, 30 m, the desired field of view is wider in order map out the objects surrounding the vehicle, such as other vehicles, pedestrians, street signs, etc., and the required angular resolutions are larger, for the reasons outlined above.

Scanning systems may be undesirable due to expense and/or reliability issues. Moreover, mechanically rotating systems may be undesirable due to inefficiencies associated with scanning a full 360 degrees, while many applications may require acquisition from less than 360 degrees. Flash-type lidar, which can use a pulsed light emitting array to emit light for short durations over a relatively large area to acquire images, may allow for solid-state imaging of a large field of view or scene. Flash lidar systems may not require careful alignment, may be cheaper to assemble, and may provide higher resolution 3D point clouds in comparison to some scanning lidar systems.

### SUMMARY

Some embodiments described herein provide methods, systems, and devices including electronic circuits to address the above and other problems by providing a lidar system including a lidar emitter having one or more light emitter elements (including one or more semiconductor lasers, such as surface- or edge-emitting laser diodes, including vertical cavity surface emitting lasers (VCSELs); generally referred to herein as emitters), and a lidar detector having one or more light detector pixels (including one or more semiconductor photodetectors, such as photodiodes, including avalanche photodiodes and single-photon avalanche detectors (SPADs); generally referred to herein as detectors). The lidar system further includes one or more switchable optical elements (e.g., opto-electronic and/or opto-mechanical elements, such as actuatable lenses, reflectors, and/or electrochromic devices) that are configured to provide light to and/or from the emitters and the detectors, and one or more control circuits configured to operate the emitters and/or detectors (including respective emitters and/or detectors thereof). The switchable optical element(s) is/are configured to be switched between two or more different optical characteristics, so as to selectively provide different fields of view or angular resolutions based on the imaging conditions (e.g., short range or long range imaging) or associated operating modes (e.g., short range mode or long range mode).

For example, first optical elements or characteristics may be used to direct light to the detector array when imaging closer distance ranges, and second optical elements or characteristics may be used to direct light to the detector array when imaging farther distance ranges. The emitter array may be operated to provide wider or narrower fields of illumination in conjunction or synchronization with the switching of the optical characteristics for the detector array. The switching between optical characteristics may be implemented by providing optical paths to or blocking optical paths from one or more fixed optical elements in some embodiments.

In some embodiments the respective optical characteristics are configured to be switched by a control circuit (e.g., a central processing unit) based on detection or determination of the imaging conditions or operating environment, for example, based on detected speed, positioning (e.g., GPS), and/or target density of an operating environment (which may indicate that the long range or short range mode is desired or applicable).

In some embodiments, the switchable optical element(s) may include an electromechanically actuated optical element that is configured to direct light from a first optical element to the detector array in a first operating mode (e.g., a long range mode), and to direct light from a second optical element to the detector array in a second operating mode (e.g., a short range mode).

In some embodiments, the switchable optical element(s) may include an electromechanically actuated zoom lens that is configured to be switched between discrete focal lengths to direct light over a first (e.g., narrower) field of view to the detector array in a first operating mode (e.g., a long range mode), and to direct light over a second (e.g., wider) field of view to the detector array in a second operating mode (e.g., a short range mode).

In some embodiments, the switchable optical element(s) may include an electrochromic optical element that is configured to be switched between a first state that allows passage of light to the detector array and a second state that blocks passage of light to the detector array.

According to some embodiments, a Light Detection and Ranging (LIDAR) system, includes a lidar detector comprising one or more detector pixels configured to detect light incident thereon; and at least one switchable optical element that is configured to direct the light to the lidar detector, where the at least one switchable optical element is configured to be switched between first and second optical characteristics that provide different first and second fields of view, respectively.

In some embodiments, the at least one switchable optical element comprises first and second lens elements having the first and second optical characteristics, respectively.

In some embodiments, the at least one switchable optical element further comprises one or more reflective elements that are configured to be switched between first and second positions, wherein the first position directs the light from the first lens element to the lidar detector, and the second position directs the light from the second lens element to the lidar detector.

In some embodiments, the at least one switchable optical element further comprises one or more electrochromic elements that are configured to be switched between first and second states, wherein the first state allows passage of the light from the first or second lens element to the lidar detector, and the second state blocks passage of the light from the first or second lens element to the lidar detector.

In some embodiments, the at least one switchable optical element comprises an actuatable lens element that is configured to be switched between first and second discrete focal lengths to provide the first and second optical characteristics, respectively.

In some embodiments, a first angular resolution of the first field of view is less than a second angular resolution of the second field of view.

In some embodiments, the at least one switchable optical element is configured to direct the light to first and second subsets of the detector pixels to provide the first and second angular resolutions, respectively, wherein the first subset is smaller than the second subset.

In some embodiments, at least one control circuit is configured to switch the at least one switchable optical element between the first and second optical characteristics in first and second imaging modes, respectively.

In some embodiments, a lidar emitter includes one or more emitter elements configured to be switched to emit optical signals over first and second fields of illumination corresponding to the first and second fields of view, respectively.

In some embodiments, the at least one control circuit is configured to activate a first subset of the emitter elements to provide the first field of illumination in the first imaging mode, and to activate a second subset of the emitter elements to provide the second field of illumination in the second imaging mode. The first imaging mode is configured to image a farther distance range than the second imaging mode.

In some embodiments, the first subset comprises centrally-arranged ones of the emitter elements, and wherein the second subset comprises peripherally-arranged ones of the emitter elements.

In some embodiments, a first population density of the first subset of the emitter elements is greater than a second population density of the second subset of the emitter elements.

In some embodiments, the lidar emitter further comprises at least one first patterned surface aligned with the first subset of the emitter elements, wherein the first patterned surface is configured to alter the propagation of the optical signals from the first subset of the emitter elements to provide the first field of illumination; and at least one second patterned surface aligned with the second subset of the emitter elements, where the second patterned surface is configured to alter the propagation of the optical signals from the second subset of the emitter elements to provide the second field of illumination.

In some embodiments, the lidar emitter further comprises a substrate having the one or more emitter elements on a surface thereof, where the surface of the substrate is non-planar and configured to orient the first and second subsets of the emitter elements to illuminate the first and second fields of illumination, respectively.

In some embodiments, the at least one control circuit is configured to operate the at least one switchable optical element to provide the first and second fields of view for respective strobe windows between pulses of the optical signals that provide the first and second fields of illumination, respectively. The respective strobe windows correspond to respective acquisition subframes of the lidar detector, where each acquisition subframe comprises data collected for a respective distance sub-range of a distance range, and where an image frame comprises the respective acquisition subframes for each of the distance sub-ranges of the distance range.

According to some embodiments, a method of operating a Light Detection and Ranging (LIDAR) system includes providing a lidar detector comprising one or more detector pixels configured to detect light incident thereon; providing at least one switchable optical element that is configured to direct the light to the lidar detector; and operating the at least one switchable optical element to switch between first and second optical characteristics that provide different first and second fields of view, respectively.

In some embodiments, the at least one switchable optical element comprises first and second lens elements having the first and second optical characteristics, respectively.

In some embodiments, operating the at least one switchable optical element further comprises operating one or more reflective elements to switch between first and second positions that direct the light from the first and second lens elements to the lidar detector, respectively.

In some embodiments, operating the at least one switchable optical element further comprises operating one or more electrochromic elements to switch between first and second states that allow and block passage of the light, respectively, from the first or second lens element to the lidar detector.

In some embodiments, operating the at least one switchable optical element further comprises operating an actuatable lens element to switch between first and second discrete focal lengths to provide the first and second optical characteristics, respectively.

In some embodiments, a first angular resolution of the first field of view is less than a second angular resolution of the second field of view.

In some embodiments, operating the at least one switchable optical element to switch between the first and second optical characteristics directs the light to first and second subsets of the detector pixels to provide the first and second angular resolutions, respectively, where the first subset is smaller than the second subset.

In some embodiments, the method further comprises providing a lidar emitter comprising one or more emitter elements configured to emit optical signals; and operating the lidar emitter to emit the optical signals over first and second fields of illumination corresponding to the first and second fields of view, respectively.

In some embodiments, operating the lidar emitter comprises activating a first subset of the emitter elements to provide the first field of illumination in a first imaging mode; and activating a second subset of the emitter elements to provide the second field of illumination in a second imaging mode, where the first imaging mode is configured to image a farther distance range than the second imaging mode.

According to some embodiments, a Light Detection and Ranging (LIDAR) system includes a lidar detector comprising one or more detector pixels configured to detect light incident thereon; at least one optical element that is configured to direct the light to the lidar detector, where the at least one optical element comprises first and second optical characteristics that provide different first and second fields of view, respectively; and a lidar emitter comprising one or more emitter elements configured to emit optical signals over first and second fields of illumination corresponding to the first and second fields of view provided by the at least one optical element, respectively.

In some embodiments, the at least one optical element comprises first and second lens elements having the first and second optical characteristics, respectively.

In some embodiments, the at least one optical element comprises one or more reflective elements configured to be switched between first and second positions that direct the light from the first and second lens elements to the lidar detector, respectively; one or more electrochromic elements configured to be switched between first and second states that allow and block passage of the light, respectively, from the first or second lens element to the lidar detector; or an actuatable lens element configured to be switched between first and second discrete focal lengths to provide the first and second optical characteristics, respectively.

In some embodiments, a first angular resolution of the first field of view is less than a second angular resolution of the second field of view.

In some embodiments, at least one control circuit is configured to switch the at least one optical element between the first and second optical characteristics in first and second imaging modes, respectively, where the first imaging mode is configured to image a farther distance range than the second imaging mode.

In some embodiments, the LIDAR system is configured to be coupled to a vehicle such that the lidar emitter and lidar detector are oriented relative to an intended direction of travel of the vehicle.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a schematic block diagram illustrating an example of a lidar system or circuit in accordance with embodiments of the present invention.

FIG. 2 is a schematic block diagram illustrating components of a ToF measurement system or circuit in a lidar application in accordance with some embodiments of the present invention.

FIGS. 3, 4, and 5 are schematic diagrams illustrating examples of emitter modules in accordance with some embodiments of the present invention.

FIGS. 6A and 6B are schematic diagrams illustrating example operation of a detector module in accordance with some embodiments of the present invention.

FIGS. 7A and 7B are schematic diagrams illustrating example operation of a detector module in accordance with further embodiments of the present invention.

FIGS. 8A and 8B are schematic diagrams illustrating example operation of a detector module in accordance with some further embodiments of the present invention.

### DETAILED DESCRIPTION OF EMBODIMENTS

In the following detailed description, numerous specific details are set forth to provide a thorough understanding of embodiments of the present disclosure. However, it will be understood by those skilled in the art that the present disclosure may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the present disclosure are described herein with reference to lidar applications and systems. A lidar system may include an array of emitters and an array of detectors, or a system having a single emitter and an array of detectors, or a system having an array of emitters and a single detector. As described herein, one or more emitters may define an emitter unit, and one or more detectors may define a detector pixel. A detector pixel may also include or provide outputs to dedicated circuits, such as storage and logic circuits, which are not shared with other pixels, referred to herein as an “in-pixel” configuration. A flash lidar system may acquire images by emitting light from an array of emitters, or a subset of the array, for short durations (pulses) over a FoV or scene, and detecting the echo signals reflected from one or more targets in the FoV at one or more detectors.

In embodiments described herein, a detection window or strobe window may refer to the respective durations of activation and deactivation of one or more detectors (e.g., responsive to respective detector time gates/control signals from a control circuit) over a temporal period or time between pulses of the emitter(s) (which may likewise be responsive to respective emitter control signals from a control circuit). The relative timings and durations of the respective detection windows may be controlled by respective strobe signals as described herein, in which case the detection windows may be referred to as strobe windows. Some embodiments may operate with strobe windows of longer time durations and corresponding farther distance subranges (e.g., with each strobe window corresponding to a 200 meter (m) distance subrange), or even as a single-strobe system whereby the full or overall imaging distance range (e.g., 400 m) is imaged or acquired at once (i.e., over a single strobe window; also referred to as single full range acquisition).

Some embodiments of the present invention may arise from realization that, while conventional lidar systems may typically either offer long-range, narrow field of view (FOV) and fine angular resolution (described herein as long range lidar), or short-range, wide field of view and gross or coarse angular resolution (described herein as short range lidar), it may be desirable to provide a lidar system with long-range, wide FOV, and fine resolution at low power consumption and cost. However, this combination has been heretofore difficult to achieve, as power requirements of lidar systems may scale exponentially with (e.g., as a square of) the range and linearly with the solid-angle being imaged. Some conventional vehicular lidar implementations may utilize more than one lidar system per vehicle (e.g., each with different range characteristics), which may require larger space, a more expensive bill-of-materials, and/or more complex fusion of the data from the various sensors on the vehicle.

Embodiments of the present invention may provide lidar systems, including emitter and/or detector modules, that are configured to provide long range lidar performance in some conditions or operating environments (e.g., while driving on a freeway), and short range lidar performance in other conditions or operating environments (e.g., in urban driving). The lidar system (such as a flash lidar system) may be described herein with reference to an angular field of view, e.g., 25 degrees horizontal by 25 degrees vertical. The lidar emitter (such as an array of emitter elements) illuminates or emits optical signals over a field of illumination, and the lidar receiver or detector (such as an array of detector pixels) images or receives light including reflections or echos of the optical signals over a field of detection. The field of view of the lidar system may thus be referred to herein as including the field of illumination of optical signal emission from the lidar emitter, the field of detection over which light is detected by the lidar receiver or detector (also referred to as a detector field of view), and the intersection thereof.

Embodiments of the present invention relate to both indirect ToF (iToF) and direct ToF (dToF) non-mechanically scanning lidar systems. Embodiments of the present invention relate to both electrically-scanning (also referred to herein as e-scanning) and flash or staring lidar systems. The description herein is primarily with reference to dToF lidar systems, but it will be understood that embodiments described herein can be applied to iToF lidar systems as well.

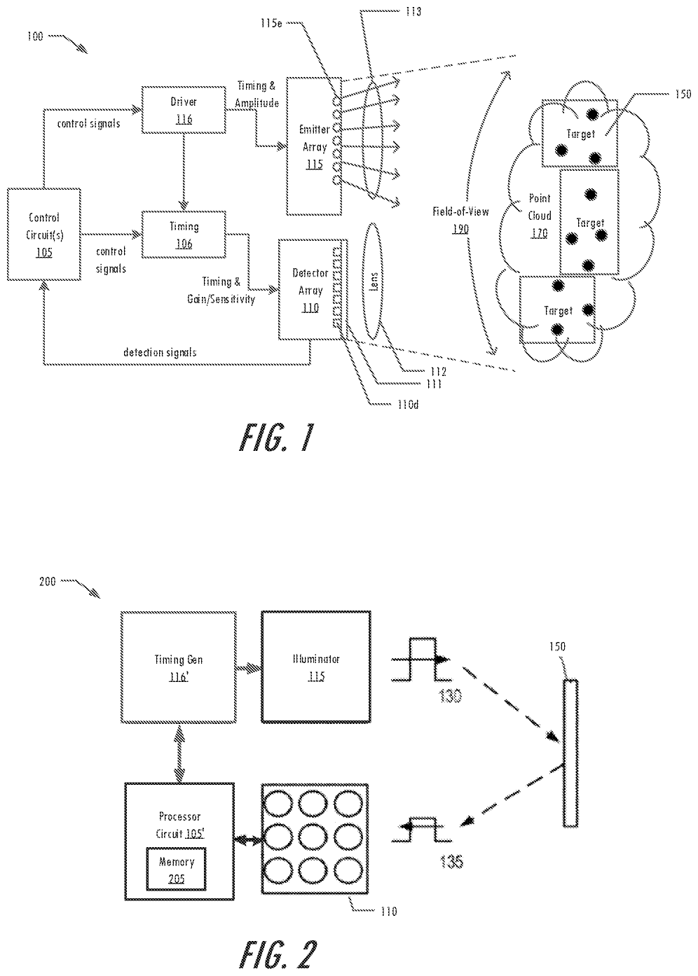

An example of a lidar system or circuit 100 in accordance with embodiments of the present disclosure is shown in FIG. 1. The lidar system 100 includes a control circuit 105, a timing circuit 106, lidar emitter implemented as an emitter array 115 including a plurality of emitters 115e, and a lidar detector implemented as a detector array 110 including a plurality of detectors 110d. The detectors 110d include time-of-flight sensors (for example, an array of single-photon detectors, such as SPADs). One or more of the emitter elements 115e of the emitter array 115 may define emitter units that respectively emit a radiation pulse or continuous wave signal at a time and frequency controlled by a timing generator or driver circuit 116. In particular embodiments, the emitters 115e may be pulsed light sources, such as LEDs or lasers (such as vertical cavity surface emitting lasers (VCSELs)), that are configured to emit light with the operational wavelength range of the lidar system 100. Radiation is reflected back from a target 150, and is sensed by detector pixels defined by one or more detector elements 110d of the detector array 110. The control circuit 105 implements a pixel processor that measures and/or calculates the time of flight of the illumination pulse over the journey from emitter array 115 to target 150 and back to the detectors 110d of the detector array 110, using direct or indirect ToF measurement techniques.

In some embodiments, an emitter module or circuit 115 may include an array of emitter elements 115e (e.g., VCSELs), a corresponding array of optical elements 113 coupled to one or more of the emitter elements (e.g., lens(es) 113, such as microlenses), and/or driver electronics 116. The optical elements 113 may be configured to provide a sufficiently low beam divergence of the light output from the emitter elements 115e so as to ensure that respective fields of illumination of either individual or groups of emitter elements 115e do not significantly overlap, and yet provide a beam divergence of the light output from the emitter elements 115e to provide eye safety to observers. The emitters 115e may be provided on a non-planar or curved or flexible substrate (e.g., substrates 301, 401, 501 discussed below) so as to contribute to the desired illumination pattern.

The driver electronics 116 may each correspond to one or more emitter elements, and may each be operated responsive to timing control signals with reference to a master clock and/or power control signals that control the peak power of the light output by the emitter elements 115e. In some embodiments, each of the emitter elements 115e in the emitter array 115 is connected to and controlled by a respective driver circuit 116. In other embodiments, respective groups of emitter elements 115e in the emitter array 115 (e.g., emitter elements 115e in spatial proximity to each other), may be connected to a same driver circuit 116. The driver circuit or circuitry 116 may include one or more driver transistors configured to control the modulation frequency, timing and amplitude of the optical signal emission that is output from the emitters 15e. The maximum optical power output of the emitters 115e may be selected to generate a signal-to-noise ratio of the echo signal from the farthest, least reflective target at the brightest background illumination conditions that can be detected in accordance with embodiments described herein.

Light emission output from one or more of the emitters 115e impinges on and is reflected by one or more targets 150, and the reflected light is detected as an optical signal (also referred to herein as a return signal, echo signal, or echo) by one or more of the detectors 110d (e.g., via receiver optics 112), converted into an electrical signal representation (referred to herein as a detection signal), and processed (e.g., based on time of flight) to define a 3-D point cloud representation 170 of a field of view 190. Operations of lidar systems in accordance with embodiments of the present disclosure as described herein may be performed by one or more processors or controllers, such as the control circuit 105 of FIG. 1.

In some embodiments, a receiver/detector module or circuit 110 includes an array of detector pixels (with each detector pixel including one or more detectors 110d, e.g., SPADs), receiver optics 112 (e.g., one or more lenses to collect light over the field of view 190), and receiver electronics (including timing circuit 106) that are configured to power, enable, and disable all or parts of the detector array 110 and to provide timing signals thereto. The detector pixels can be activated or deactivated with at least nanosecond precision, and may be individually addressable, addressable by group, and/or globally addressable. The receiver optics 112 may include a macro lens that is configured to collect light from the largest field of view that can be imaged by the lidar system, microlenses to improve the collection efficiency of the detecting pixels, and/or anti-reflective coating to reduce or prevent detection of stray light. In some embodiments, a spectral filter 111 may be provided to pass or allow passage of “signal” light (i.e., light of wavelengths corresponding to those of the optical signals output from the emitters) but substantially reject or prevent passage of “background” or non-signal light (i.e., light of wavelengths different than the optical signals output from the emitters). The detectors 110d may be provided in an array 110 and/or the collection optics 112 may be configured so as to image respective portions of a desired field of detection.

The detectors 110d of the detector array 110 are connected to the timing circuit 106. The timing circuit 106 may be phase-locked to the driver circuitry 116 of the emitter array 115. The sensitivity of each of the detectors 110d or of groups of detectors may be controlled. For example, when the detector elements include reverse-biased photodiodes, avalanche photodiodes (APD), PIN diodes, Silicon Photomultipliers (SiPM) and/or Geiger-mode Avalanche Diodes (SPADs), the reverse bias may be adjusted, whereby, the higher the overbias, the higher the sensitivity.

In some embodiments, a control circuit 105, such as a microcontroller or microprocessor, provides different emitter control signals to the driver circuitry 116 of different emitters 115e and/or provides different signals (e.g., strobe signals) to the timing circuitry 106 of different detectors 110d to enable/disable different detectors 110d (or subsets of detectors 110d in different regions of the array 110) so as to detect the echo signals from targets 150 in different fields of view, in some instances during different portions of an imaging frame or subframe. The control circuit 105 may also control memory storage operations for storing data indicated by the detection signals in a non-transitory memory or memory array 205.

“Strobing” as used herein may refer to the generation of detector control signals (also referred to herein as strobe signals or “strobes”) to control the timing and/or duration of activation (detection or strobe windows) of one or more detectors 110d of the lidar system 100. That is, some embodiments described herein can utilize range strobing (i.e., biasing the SPADs to be activated and deactivated for durations or windows of time over the emitter cycle, at variable delays with respect to the firing of the emitter (e.g., a laser), thus capturing reflected signal photons corresponding to specific distance sub-ranges at each window/frame) to limit the number of ambient photons acquired in each emitter cycle. An emitter cycle (e.g., a laser cycle) refers to the time between emitter pulses. In some embodiments, the emitter cycle time is set as or otherwise based on the time required for an emitted pulse of light to travel round trip to the farthest allowed target and back, that is, based on a desired distance range.

A range-strobing flash lidar (e.g., with strobe windows corresponding to one or more respective distance sub-ranges, and with subframes collecting data based on the detection signals output during a respective strobe window) may use strobing for several reasons. For example, in some embodiments, detector elements may be combined into pixels and the detector elements and/or pixels may be selectively activated after the emission of optical signals to detect echo signals from a target during specific strobe windows. The detected echo signals may be used to generate a histogram of detected “counts” of photons incident on the detector from the echo signal. Examples of methods to detect a target distance based on histograms are discussed, for example, in U.S. Patent Application Publication No. 2019/0250257, entitled “Methods And Systems For High-Resolution Long-Range Flash Lidar,” the contents of which are incorporated herein by reference.

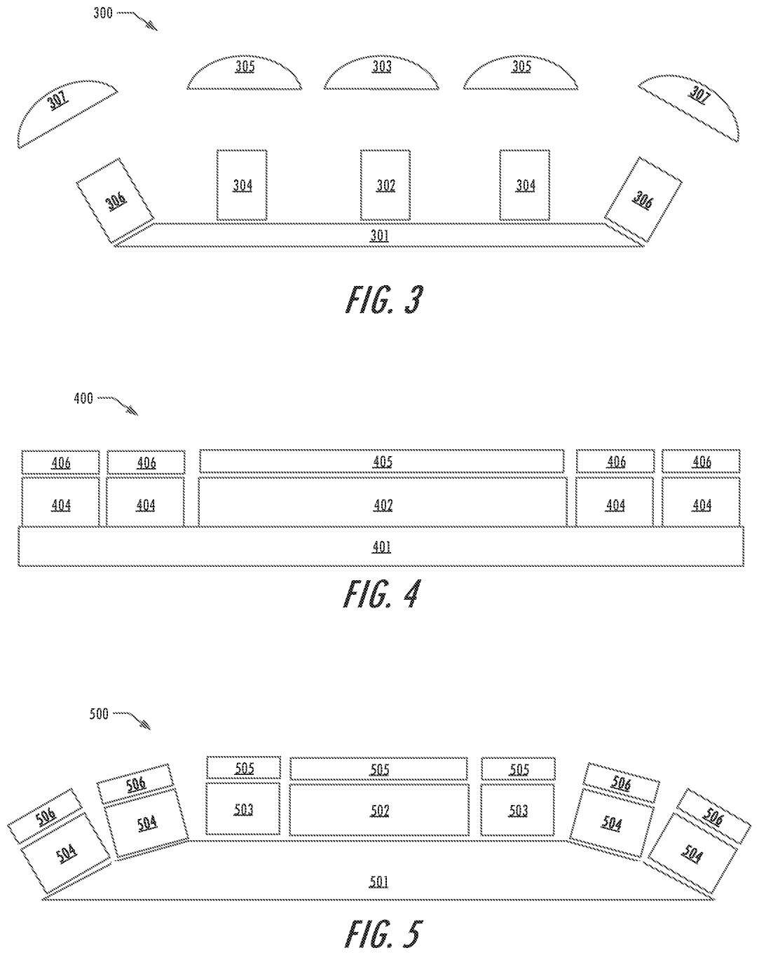

FIG. 2 further illustrates components of a ToF measurement system or circuit 200 in a LIDAR application in accordance with some embodiments described herein. The circuit 200 may include a processor circuit 105′ (such as a digital signal processor (DSP)), a timing generator 116′ which controls timing of the illumination source (illustrated by way of example with reference to a laser emitter array 115), and an array of single-photon detectors (illustrated by way of example with reference to the detector array 110). The processor circuit 105′ may also include a sequencer circuit that is configured to coordinate operation of the emitters 115e and detectors 110d.

The processor circuit 105′ and the timing generator 116′ may implement some of the operations of the control circuit 105 and the driver circuit 116 of FIG. 1. The emitter array 115 emits a laser pulse 130 at a time controlled by the timing generator 116′. Light 135 from the laser pulse 130 is reflected back from a target (illustrated by way of example as object 150), and is sensed by the detector array 110. The processor circuit 105′ implements a pixel processor that measures the ToF of the laser pulse 130 and its reflected signal 135 over the journey from emitter array 115 to object 150 and back to the detector array 110.

The processor circuit 105′ may provide analog and/or digital implementations of logic circuits that provide the necessary timing signals (such as quenching and gating or strobe signals) to control operation of the single-photon detectors of the array 110 and process the detection signals output therefrom. For example, the single-photon detectors of the array 110 may generate detection signals in response to incident photons only during the short gating intervals or strobe windows that are defined by the strobe signals. Photons that are incident outside the strobe windows have no effect on the outputs of the single photon detectors. More generally, the processor circuit 105′ may include one or more circuits that are configured to generate the respective detector control signals that control the timing and/or durations of activation of the detectors 110d, and/or to generate respective emitter control signals that control the output of optical signals from the emitters 115e. Detection events may be identified by the processor circuit 105′ based on one or more photon counts indicated by the detection signals output from the detector array 110, which may be stored in the memory 205.

The field of view 190 shown in FIG. 1 may include multiple fields of view that can be imaged by lidar systems in accordance with embodiments of the present disclosure. In some embodiments, the respective fields of illumination of the emitter array 115 and/or fields of view of the detector array 110 are configured to be controlled by a control circuit (e.g., a central processing unit), such as the control circuit 105 or the processor circuit 105′.

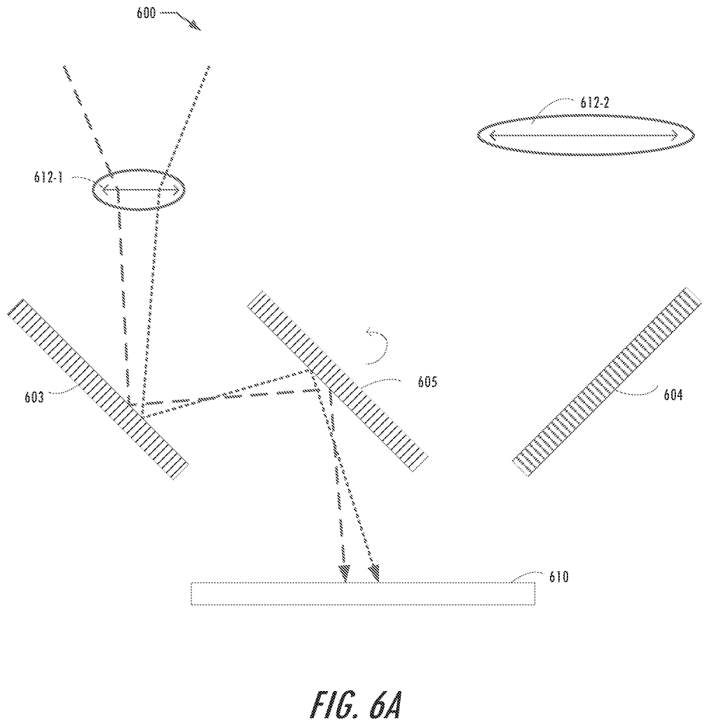

In some embodiments, the emitter array 115 may be configured as an emitter module 300, as shown in FIG. 3. More than one emitter 302, 304, 306 is arranged on a substrate 301. The substrate 301 may be thermally conductive, e.g., with a relatively high heat conductivity and high heat capacity. In some embodiments, the emitters 302, 304, 306 may be electrically interconnected to and/or on the substrate 301. In some embodiments, the interconnections may have low inductance, e.g., a vertical interconnection without wirebonds. For example, the emitters 302, 304, 306 may be serially connected anode-to-cathode on a non-native substrate 301 by thin film interconnections (not shown). In some embodiments, the emitter module 300 may include a non-native (e.g., curved or flexible) substrate 301 having thousands of discrete emitters 302, 304, 306 electrically connected in series and/or parallel thereon, with driver circuit(s) implemented by driver transistors integrated on the non-native substrate adjacent respective rows and/or columns of the emitter array, as described for example in U.S. Patent Application Publication No. 2018/0301872 to Burroughs et al., the disclosure of which is incorporated by reference herein.

The emitters 302, 304, 306 may be edge-emitting lasers, or surface-emitting lasers (such as VCSELs). Each of the emitters 302, 304, and 306 may be aligned with or coupled to one or more optical elements 303, 305, and 307, respectively. Centrally-arranged emitters 302 may be configured to emit laser pulses at a repetition rate and power sufficient to illuminate targets in a long-range configuration or imaging mode, and optical elements 303 may be configured to shape the beam to illuminate a first, long-range field of illumination. Peripherally-arranged emitters 304 and/or 306 may be configured to emit laser pulses at a repetition rate and power sufficient to illuminate targets in a short-range configuration or imaging mode, and optical elements 305 and/or 307 may be configured to shape the beam to illuminate a second, short-range field of illumination. More generally, the optical elements 303, 305, and 307 may respectively be configured to provide a desired beam shaping, e.g., based on the corresponding ones of the emitter elements 302, 304, and 306 aligned therewith. A processing unit (such as the control circuit 105 or the processor circuit 105′) may be configured to activate different groups or subsets of the emitters 302, 304, 306 to provide respective fields of illumination in respective imaging modes, primarily described herein with reference to first and second imaging modes, a long-range and short-range imaging modes. However, it will be understood that embodiments of the present invention are not limited to two imaging modes, and may include three (e.g., long-range, mid-range, and short range) or more imaging modes in some embodiments.

For example, the processing unit may be configured to activate a first group or subset of the emitters (e.g., the centrally-arranged emitters 302) to operate in the long-range imaging mode, for example with a peak power of 5 kW, a pulse width of 2 ns and a repetition rate of 750 kHz. In some embodiments, the power output of the emitter(s) 302 may be modulated for strobed time of flight (ToF), e.g., the emitter(s) 302 may be stepped through multiple (for example, 20) different power levels in each imaging frame (where an imaging frame may include a collection of subframes, each associated with a respective distance subrange). Optical elements 303 are designed or configured to shape the beam output from the centrally-arranged emitters 302 to illuminate the first field of illumination in the long-range imaging mode, for example, covering an angular range of about 25 degrees horizontal by 25 degree vertical. For example, the emitters 302 may be activated to illuminate a long range field of illumination responsive to a perception engine or other processing unit determining that a vehicle is driving on a highway, or other operating mode or situation when longer range imaging may be desirable (e.g., as indicated by GPS coordinates). In the long-range mode, the peripherally-arranged emitters 304 and 306 may be disabled, powered-down, or operated at relatively lower-power (in comparison to the centrally arranged emitters 302) such that the emitters 304 and 306 can be switched on sufficiently quickly as desired, for example, responsive to a change in the operating mode or situation.

Still referring to FIG. 3, the processing unit may be configured to activate a second group or subset of the emitters (e.g., the emitters 302, 304, 306) to operate in the short-range imaging mode, for example, responsive to determining that a vehicle is driving in an urban setting or other operating mode or situation when shorter range imaging may be desirable (e.g., as indicated by GPS coordinates). In the short-range mode, some or all of the emitters 302, 304, and/or 306 may be activated to illuminate a wide field of illumination. For example, emitters 302, 304 and 306 may emit 3 ns pulses at a peak power of 3 kW with a repetition rate of 2 NMz. In some embodiments, fewer (e.g., two) power levels per imaging frame may be used in a modulation scheme for the short-range imaging mode as compared to the long-range imaging mode. Optical elements 305 and 307 may be configured to produce the desired beam profile for the short-range imaging mode in combination with the optical elements 303. For example, optical elements 305 and 307 may produce an approximately top hat-shaped intensity profile (i.e., a substantially uniform intensity within a given area) covering an angular range of about 100 degrees (e.g., horizontal) by 25 degrees (e.g., vertical) in the short-range imaging mode.

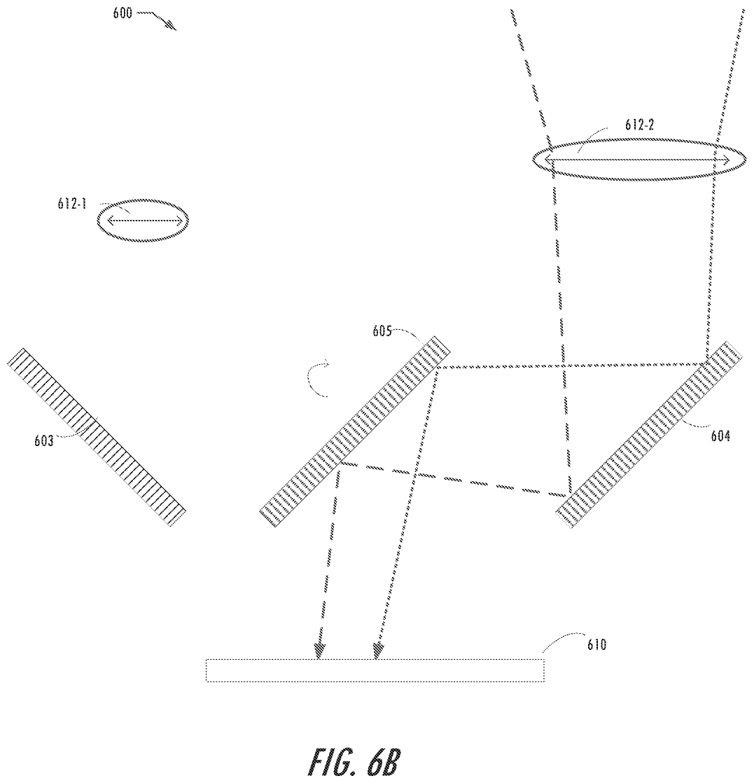

In some embodiments, the emitter array 115 may be configured as an emitter module 400 as shown in FIG. 4. As shown in FIG. 4, the emitter module 400 may include an array of emitters 402, 404. For example, the array of emitters 402, 404 may be an array of surface-emitting lasers, such as VCSELs. In some embodiments, more than one array of VCSELs may be included in the emitter module 400. The emitters 402, 404 of each array may be electrically interconnected to and/or on the substrate 401. For example, the emitters 402, 404 may be serially connected anode-to-cathode on a non-native substrate 401 by thin film interconnections (not shown).

Similar to the configuration of FIG. 3, a processing unit (such as the control circuit 105 or the processor circuit 105′) may be configured to activate different groups or subsets of the emitters 402, 404 to provide respective fields of illumination in respective imaging modes. For example, centrally-arranged emitters 402 may be configured to emit laser pulses at a repetition rate and power sufficient to provide a first field of illumination, e.g., to illuminate targets in a long-range configuration or imaging mode. Peripherally-arranged emitters 404 (alone or in combination with the centrally-arranged emitters 402) may be configured to emit laser pulses at a repetition rate and power sufficient to provide a second field of illumination, e.g., to illuminate targets in a short-range configuration or imaging mode.

The substrate 401 may also include one or more driver circuits (not shown) for the emitters 402, 404 or multiple arrays of emitters 402, 404. The driver circuit(s) may be configured to provide current (or voltage) modulation to each of the emitters 402, 404 or emitter arrays in the respective imaging modes to provide the respective fields of illumination. For example, when operating in the long-range imaging mode, the driver circuit may be configured to provide or drive a peak current of about 10 A in 2 ns pulses and a 750 kHz repetition rate to the emitter array 402. Likewise, when operating in short-range imaging mode, the driver circuit may be configured to modulate the current (or voltage) and/or pulse repetition rate to the emitters 402, 404 to achieve the desired short-range performance.

One or more optical elements may be formed on top of or otherwise aligned with the centrally-arranged emitters 402 and may be configured to provide respective fields of illumination. For example, in some embodiments, one or more lenses (not shown) may be aligned to the central emitter array 402 and configured to shape the output beams therefrom to illuminate a first field of illumination, corresponding to the long-range lidar. Additionally or alternatively, a structured optical surface (also referred to herein as a patterned surface) 405, such as an array of microlenses or a diffuser or a diffractive optical element, may be formed on top of or otherwise aligned with the emitter array 402. The patterned surface 405 may be configured to alter the propagation of the output beams from the emitters 402 to provide the first field of illumination for the long-range operating mode. For example, patterned surface 405 may be a uniform array of microlenses formed directly on and centered on the emitter array 402. The peripherally arranged emitters (or arrays) 404 may be powered-down, powered-off, or otherwise inactive during the long-range operating mode.

Similarly, peripheral patterned or structured surfaces 406 may be formed on top of or otherwise aligned with the peripherally-arranged emitters 404. The peripheral structured surfaces 406 are configured to alter the propagation of the output beams from the emitters 404 to generate the desired beam shape to provide a second (e.g., wider) field of illumination for the short-range operating mode. For example, the peripheral structured surfaces 406 may be an array of microlenses which are offset with respect to the center apertures of the peripheral emitters 404, so as to offset the resulting beams to define the second field of illumination. In some embodiments the structured surfaces 405 and/or 406 may include diffusers with an off-axis output beam shape. The first and second fields of illumination may overlap; for example, a central portion of the first and second fields of illumination may be common to both the long-range and short-range emitter operating modes.

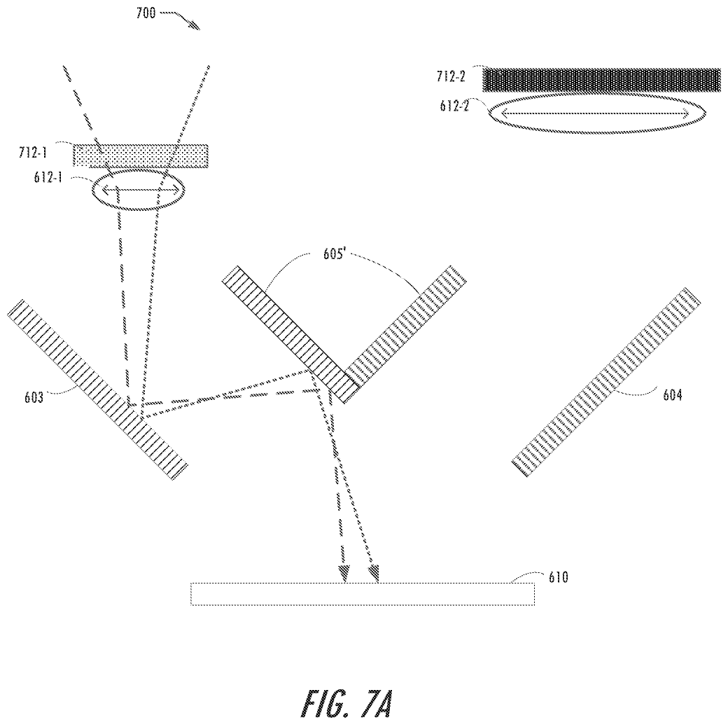

In some embodiments, the emitter array 115 may be configured as an emitter module 500 as shown in FIG. 5. As shown in FIG. 5, the emitter module 500 may include an array of emitters 502, 503, 504 on a substrate 501, with the centrally-arranged emitters 502 configured to emit laser pulses at a repetition rate and power sufficient to provide a first field of illumination (e.g., to illuminate targets in a long-range imaging mode) and peripherally-arranged emitters 503, 504 configured to emit laser pulses at a repetition rate and power (alone or in combination with the centrally-arranged emitters 502) sufficient to provide a second field of illumination (e.g., to illuminate targets in a short-range configuration or imaging mode). One or more optical elements (such as patterned surfaces 505, 506, which may include an array of microlenses or a diffuser or a diffractive optical element) may be formed on top of or otherwise aligned with the emitters 502, 503, 504, and may be configured to alter the propagation of the output beams from the emitters 502, 503, 504 to generate the desired beam shapes to provide the first and second fields of illumination. The emitters 502, 503, 504 may otherwise be connected to one another and/or controlled in a manner similar to that described above with reference to FIG. 4.

In contrast to the substrate 401 of FIG. 4, the substrate 501 of FIG. 5 is non-planar, for example, multi-faceted (e.g., machined and polished), such that the emitters 502, 503, 504 mounted or attached thereon are oriented to illuminate specific angles to provide the resulting beam shapes of the peripheral emitters 504 to correspond to the wider second field of illumination. In some embodiments, the emitters 502, 503 and/or 504 may include VCSELs transfer-printed on a flexible substrate (not shown), which is then attached to a rounded, multi-faceted, or other non-planar substrate 501. The total horizontal field of illumination may be determined by the curvature or facets of the substrate 501, while the vertical field of illumination may be determined by a diffuser, or vice versa. In some embodiments, a density of population of the emitters 502 in the central region configured to illuminate the first field of illumination is different (e.g., greater) than the density of population of the emitters 503, 504 in the periphery. In some embodiments, the emitters 502, 503, 504 may be oriented to illuminate specific angles to provide the first and second fields of illumination, respectively, free of one or more lens elements (e.g., based on the orientations provided by the non-planar substrate.

In some embodiments, in long-range imaging mode, only the emitters 502 in the high density central region may be activated to provide the first field of illumination. In the short-range imaging mode, up to the entire VCSEL array or otherwise up to all of the emitters 502, 503, 504 may be activated, but the higher density VCSELs 502 may be driven at a lower current such that the optical emission density is substantially uniform across the second field of illumination. In some embodiments, in short-range imaging mode, only some of the VCSELs 502 in the high density central region may be activated, for example, by only powering subsets (e.g., some of strings) of the VCSELs 502 and leaving other subsets of the VCSELs 502 unpowered.

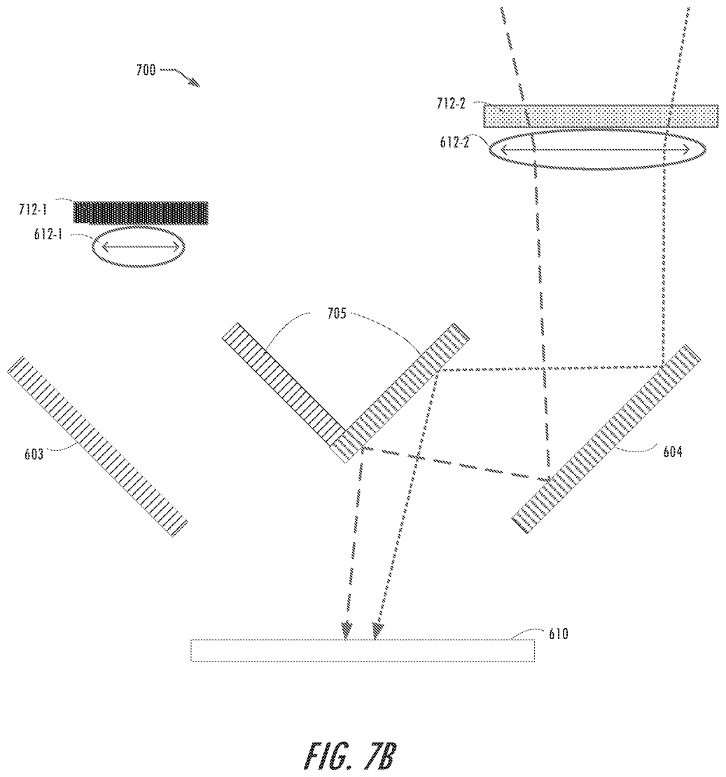

In some embodiments, the detector array 110 may be configured as a light receiver or detector module 600, 700, 800. FIGS. 6A and 6B illustrate operation of a light receiver or detector module 600 configured to image multiple different fields of view in accordance with some embodiments of the present invention. Costs associated with a light receiver or lidar detector may be dominated by the cost of the sensor chip (e.g., the detector array 110) and the supporting electronics or circuits. In some embodiments of the present invention, a single or same sensor chip/detector array and supporting electronics may be configured for a multi-field of view (e.g., a dual field of view) system. A light receiver or detector module as described herein may include one or more optical elements that are configured to image approximately the same field of view as that of the emitter array onto a detector array (e.g., an array of SPADs, or an array of photon-mixing devices for indirect time-of-flight measurement), similar to those described in U.S. Patent Application Publication No. 2019/0250257 to Finkelstein et al., the disclosure of which is incorporated by reference herein in its entirety.

In detail, for a detector array with pixel diagonal h and pixel angular field of view ϕ, a lens with focal length f may be required, where h=f tan ϕ or h=f ϕ if distortion can be tolerated. For a given lens f-number, f #, the diameter D of the entrance pupil of the lens may satisfy D=f/f #. For an image sensor or detector array with n×m pixels, a largest field of view may be represented by (n ϕ)×(m ϕ). If a spectral filter has an acceptance angle Ψ, then to conserve Etendue, the filter diameter may be at least

$${D}_{f} \geq \frac{D}{Ψ} \sqrt{( {n}_{u} ϕ \times {m}_{u} ϕ )}$$

where the subscript u denotes the number of pixels in the detector array used for imaging.

As a numerical example of different optical characteristics that may be used to image long and short distance ranges, a receiver or detector module may include a sensor chip (such as the detector array 110) with 500×500 pixels, each having a 10 micron (um) diagonal, a filter (such as the spectral filter 111), and one or more optical elements (such as the collection lens 112) configured to direct light to the detector array. In a long-range imaging mode, the detector array may image about a 25 degree (e.g., horizontal)×25 degree (e.g., vertical) field of view with 0.05 degree×0.05 degree resolution, and may incorporate a filter with about a 20×20 degree acceptance angle. Based on the above and assuming no distortion, the focal length of the collection lens may be 5.7 mm. If the f-number of the collection lens is 1.5, then its pupil diameter may be 3.82 mm, and the filter diameter may be 4.78 mm. In a short-range imaging mode, the detector array may image about a 100 degree (e.g., horizontal)×100 degree (e.g., vertical) field of view with about a 0.25 degree×0.25 degree resolution. In this case the focal length of the collection lens may be 0.96 mm, and if the f-number remains 1.5 then the pupil diameter may be 0.63 mm and the filter diameter may be 3.18 mm. As illustrated in the above example, the long- and short-range imaging modes may require collection optical element(s) having different optical characteristics so as to provide the different fields of view or angular resolutions (also referred to herein as fields of detection). The different fields of view may overlap; for example, a central portion of the respective fields of view may be imaged in both the long-range and short-range imaging modes.

As shown in FIGS. 6A and 6B, in some embodiments (not necessarily corresponding to the example above), a detector module 600 includes a single sensor chip (e.g., a detector array 610) aligned with respect to a plurality of reflective optical elements (illustrated as mirrors 603, 604, 605). Electromechanically actuated-mirror(s) 605 can be switched between two (or more) pre-determined positions, each of which reflect or direct light to the detector array 610. A first position (shown in FIG. 6A) reflects light from a first fixed mirror 603 to the detector array 610, and a second position (shown in FIG. 6B) reflects light from a second fixed mirror 604 to the detector array 610. Mirror 605 may be connected to a computer-controlled mechanical stage or may be comprised of multiple electro-mechanically actuated micro-mirrors (MEMS mirrors), which may be controlled by a processing circuit or control circuit (e.g., 105, 105′) as described herein. Collection lenses 612-1 and 612-2 are configured to image a first (narrower) and second (wider) field of view, through their respective fixed mirrors 603 and 604 and the actuated mirror 605, onto the focal plane of the detector array 110. A spectral filter may be integrated with or within the lenses 612-1 and 612-2 in some embodiments.

When the lidar system including the detector module 600 shown in the example of FIGS. 6A and 6B is in a long-range image acquisition mode, a control circuit (e.g., 105, 105′) operates an actuator to move the actuated mirror 605 to reflect light from the long-range collection lens 612-1 to the detector array 610, as shown in FIG. 6A. When the lidar system including the detector module 600 is in a short-range image acquisition mode, the control circuit operates an actuator to move the actuated mirror 605 to reflect light from the short-range collection lens 612-2 to the detector array 610 as shown in FIG. 6B. Additional mirror positions and/or associated optics to provide further (e.g., 3 or more) fields of view may be similarly provided.

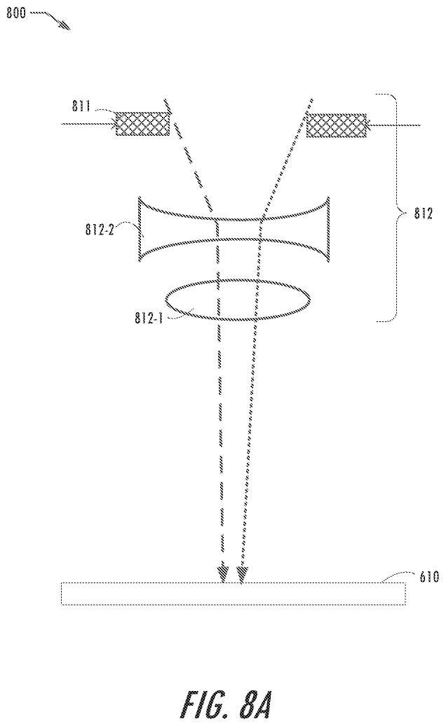

In some embodiments, a mirror constellation 603, 604, 605′ similar to the example of FIGS. 6A and 6B may be used in combination with one or more electrochromic optical elements 712-1, 712-2. As shown in FIGS. 7A and 7B, a detector module 700 includes first and second electrochromic optical elements 712-1 and 712-2. The electrochromic optical elements 712-1 and 712-2 can be switched between two pre-determined states, where the first, open state allows passage of light from the lens elements 612-1 or 612-2 to the detector array 610, and the second, closed state blocks passage of light from the lens elements 612-1 or 612-2 to the detector array 610. The respective states and coordinated operation of the electrochromic optical elements 712-1 and 712-2 may be controlled by a processing circuit or control circuit (e.g., 105, 105′) as described herein.

When the lidar system including the detector module 700 shown in the example of FIGS. 7A and 7B is in a long-range image acquisition mode, a control circuit (e.g., 105, 105′) operates the first electrochromic optical element 712-1 to be in the open state and thus directs light to the detector array 610 via the collection lens 612-1 and the fixed mirrors 603 and 605′, while the second electrochromic optical element 712-2 is in the closed state to block the passage of light (e.g., through the collection lens 612-2), as shown in FIG. 7A. When the lidar system including the detector module 600 is in a short-range image acquisition mode, the control circuit operates the second electrochromic optical element 712-2 to be in the open state and thus directs light to the detector array 610 via the collection lens 612-2 and the fixed mirrors 604 and 605′, while the first electrochromic optical element 712-1 is in the closed state to block the passage of light (e.g., through the collection lens 612-1), as shown in FIG. 7B. Although illustrated as positioned between the long-range and short range lens elements 612-1 and 612-2 and their respective fields of view, it will be understood that the electrochromic optical elements 712-1 and/or 712-2 may be positioned anywhere in the detector module 700 so as to provide the functionality of allowing or blocking light to the detector array 610 as described herein.

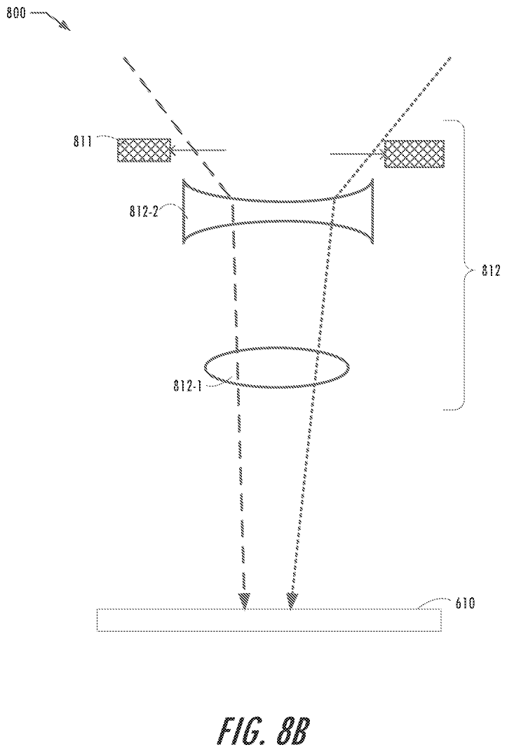

In some embodiments, rather than using the mirror constellations illustrated in the examples of FIGS. 6A-6B and 7A-7B, a motorized zoom lens 812 with two or more discrete positions may be used to direct the light from the respective fields of view to the detector array 610. As shown in FIGS. 8A and 8B, a detector module 800 includes a zoom lens 812 having one or more internal movable lenses 812-1, 812-2 and a motorized field stop 811. The distance between the detector array 610 and the zoom lens may be fixed, while the internal movable lenses 812-1, 812-2 and a motorized field stop 811 may be programmed or otherwise configured to provide, for example, multiple (e.g., two) positions corresponding to different respective fields of view or angular resolutions (e.g., for short- and long-range modes). For example, the motorized field stop 811 may have a first position (shown in FIG. 8A) and a second position (shown in FIG. 8B). One or more of the optical elements 812-1, 812-2, 811 of the zoom lens 812 may be mounted or connected to a computer-controlled mechanical stage, which may be controlled by a processing circuit or control circuit (e.g., 105, 105′) as described herein to move the elements 812-1, 812-2, and/or 811 to respective positions to direct light to the detector array 610 with a first focal length for long-range image acquisition, or a second focal length for short-range image acquisition.

In some embodiments, the same or similar sensor area (e.g., the same or substantially similar subsets of the detector pixels of the detector array) is illuminated or otherwise receives light from the different optics in both modes (e.g., the short- and long-range modes). In some embodiments, different parts or areas of the detector array (e.g., different subsets of the detector pixels) are illuminated or otherwise receive light from the different optics in each of the modes. For example, 500×500 detector pixels may be illuminated in the short-range mode, while only 400×400 pixels may be illuminated in the long-range mode, or vice versa.

In some embodiments, a control circuit (e.g., 105, 105′) may be configured to activate subsets of the detector pixels to acquire optical information in a first timing configuration corresponding to the long-range mode, and in a different, second timing configuration corresponding to the short range mode. For example, in a strobed acquisition whereby the detector pixels are activated to detect incident light for time durations corresponding to respective strobe signals from the control circuit, in long-range mode, the detector array may acquire 20 sub-frames per frame (with corresponding time offsets for each strobe gate), whereas in short-range mode the detector array may cycle through or acquire only 2 sub-frames per frame.

In some embodiments, the control circuit may be configured to activate subsets of the emitters and detector pixels in coordination to provide a field of illumination of the emitter units and/or a field of view of the detector pixels are varied based on the respective strobe windows/respective sub-ranges of a distance range, as described for example in International Publication No. WO 2021/067377 to Al Abbas et al., the disclosure of which is incorporated by reference herein.

In some embodiments, the sensor or detector array may reconfigure a per-pixel memory usage (as described for example in U.S. patent application Ser. No. 17/071,589 to Finkelstein et al., the disclosure of which is incorporated by reference herein) based on the operating or imaging mode (e.g., short-range or long-range). By way of example only, if 1302 bits are allocated per pixel and a single-strobe acquisition (e.g., with the detector array being active for a majority of the duration between emitter pulses) is used, in long-range mode about 1300 ns (per full range)/6 ns (per histogram bin)=217 bins may be used, and each bin may be allocated 5 bits. During short-range acquisition, the reduced range may translate to about 130 ns, so 50 bits may be allocated per bin, thus increasing the dynamic range of the system.

Lidar systems and arrays described herein may be applied to ADAS (Advanced Driver Assistance Systems), autonomous vehicles, UAVs (unmanned aerial vehicles), industrial automation, robotics, biometrics, modeling, augmented and virtual reality, 3D mapping, and security.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment”, “one embodiment” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts

The example embodiments are also described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

It will be understood that when an element is referred to or illustrated as being “on,” “connected,” or “coupled” to another element, it can be directly on, connected, or coupled to the other element, or intervening elements may be present. In contrast, when an element is referred to as being “directly on,” “directly connected,” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present invention described herein, and of the manner and process of making and using them, and shall support claims to any such combination or subcombination.

Although the invention has been described herein with reference to various embodiments, it will be appreciated that further variations and modifications may be made within the scope and spirit of the principles of the invention. Although specific terms are employed, they are used in a generic and descriptive sense only and not for purposes of limitation, the scope of the present invention being set forth in the following claims.

1. A Light Detection and Ranging (LIDAR) system, comprising:
a lidar detector comprising one or more detector pixels configured to detect light incident thereon; and
at least one switchable optical element that is configured to direct the light to the lidar detector, wherein the at least one switchable optical element is configured to be switched between first and second optical characteristics that provide different first and second fields of view, respectively.

2. The LIDAR system of claim 1, wherein the at least one switchable optical element comprises first and second lens elements having the first and second optical characteristics, respectively.

3. The LIDAR system of claim 2, wherein the at least one switchable optical element further comprises one or more reflective elements that are configured to be switched between first and second positions, wherein the first position directs the light from the first lens element to the lidar detector, and the second position directs the light from the second lens element to the lidar detector.

4. The LIDAR system of claim 2, wherein the at least one switchable optical element further comprises one or more electrochromic elements that are configured to be switched between first and second states, wherein the first state allows passage of the light from the first or second lens element to the lidar detector, and the second state blocks passage of the light from the first or second lens element to the lidar detector.

5. The LIDAR system of claim 1, wherein the at least one switchable optical element comprises an actuatable lens element that is configured to be switched between first and second discrete focal lengths to provide the first and second optical characteristics, respectively.

6. The LIDAR system of claim 1, wherein a first angular resolution of the first field of view is less than a second angular resolution of the second field of view.

7. The LIDAR system of claim 6, wherein the at least one switchable optical element is configured to direct the light to first and second subsets of the detector pixels to provide the first and second angular resolutions, respectively, wherein the first subset is smaller than the second subset.

8. The LIDAR system of claim 1, further comprising:
at least one control circuit that is configured to switch the at least one switchable optical element between the first and second optical characteristics in first and second imaging modes, respectively.

9. The LIDAR system of claim 8, further comprising:
a lidar emitter comprising one or more emitter elements configured to be switched to emit optical signals over first and second fields of illumination corresponding to the first and second fields of view, respectively.

10. The LIDAR system of claim 9, wherein the at least one control circuit is configured to activate a first subset of the emitter elements to provide the first field of illumination in the first imaging mode, and to activate a second subset of the emitter elements to provide the second field of illumination in the second imaging mode,
wherein the first imaging mode is configured to image a farther distance range than the second imaging mode.

11. The LIDAR system of claim 10, wherein the first subset comprises centrally-arranged ones of the emitter elements, and wherein the second subset comprises peripherally-arranged ones of the emitter elements.

12. The LIDAR system of claim 11, wherein a first population density of the first subset of the emitter elements is greater than a second population density of the second subset of the emitter elements.

13. The LIDAR system of claim 10, wherein the lidar emitter further comprises:
at least one first patterned surface aligned with the first subset of the emitter elements, wherein the first patterned surface is configured to alter the propagation of the optical signals from the first subset of the emitter elements to provide the first field of illumination; and
at least one second patterned surface aligned with the second subset of the emitter elements, wherein the second patterned surface is configured to alter the propagation of the optical signals from the second subset of the emitter elements to provide the second field of illumination.

14. The LIDAR system of claim 10, wherein the lidar emitter further comprises:
a substrate having the one or more emitter elements on a surface thereof, wherein the surface of the substrate is non-planar and configured to orient the first and second subsets of the emitter elements to illuminate the first and second fields of illumination, respectively.

15. The LIDAR system of claim 8, wherein the at least one control circuit is configured to operate the at least one switchable optical element to provide the first and second fields of view for respective strobe windows between pulses of the optical signals that provide the first and second fields of illumination, respectively,
wherein the respective strobe windows correspond to respective acquisition subframes of the lidar detector, wherein each acquisition subframe comprises data collected for a respective distance sub-range of a distance range, and wherein an image frame comprises the respective acquisition subframes for each of the distance sub-ranges of the distance range.

16. A method of operating a Light Detection and Ranging (LIDAR) system, the method comprising:
providing a lidar detector comprising one or more detector pixels configured to detect light incident thereon;
providing at least one switchable optical element that is configured to direct the light to the lidar detector; and
operating the at least one switchable optical element to switch between first and second optical characteristics that provide different first and second fields of view, respectively.

17. The method of claim 16, wherein the at least one switchable optical element comprises first and second lens elements having the first and second optical characteristics, respectively.

18. The method of claim 17, wherein operating the at least one switchable optical element further comprises:
operating one or more reflective elements to switch between first and second positions that direct the light from the first and second lens elements to the lidar detector, respectively;
operating one or more electrochromic elements to switch between first and second states that allow and block passage of the light, respectively, from the first or second lens element to the lidar detector; or
operating an actuatable lens element to switch between first and second discrete focal lengths to provide the first and second optical characteristics, respectively.

19. The method of claim 16, wherein a first angular resolution of the first field of view is less than a second angular resolution of the second field of view.

20. The method of claim 19, wherein operating the at least one switchable optical element to switch between the first and second optical characteristics directs the light to first and second subsets of the detector pixels to provide the first and second angular resolutions, respectively, wherein the first subset is smaller than the second subset.

21. The method of claim 16, further comprising:
providing a lidar emitter comprising one or more emitter elements configured to emit optical signals; and
operating the lidar emitter to emit the optical signals over first and second fields of illumination corresponding to the first and second fields of view, respectively.

22. The method of claim 21, wherein operating the lidar emitter comprises:
activating a first subset of the emitter elements to provide the first field of illumination in a first imaging mode; and
activating a second subset of the emitter elements to provide the second field of illumination in a second imaging mode,
wherein the first imaging mode is configured to image a farther distance range than the second imaging mode.

23. A Light Detection and Ranging (LIDAR) system, comprising:
a lidar detector comprising one or more detector pixels configured to detect light incident thereon;
at least one optical element that is configured to direct the light to the lidar detector, wherein the at least one optical element comprises first and second optical characteristics that provide different first and second fields of view, respectively; and
a lidar emitter comprising one or more emitter elements configured to emit optical signals over first and second fields of illumination corresponding to the first and second fields of view provided by the at least one optical element, respectively.

24. The LIDAR system of claim 23, wherein the at least one optical element comprises first and second lens elements having the first and second optical characteristics, respectively.

25. The LIDAR system of claim 24, wherein the at least one optical element comprises:
one or more reflective elements configured to be switched between first and second positions that direct the light from the first and second lens elements to the lidar detector, respectively;
one or more electrochromic elements configured to be switched between first and second states that allow and block passage of the light, respectively, from the first or second lens element to the lidar detector; or
an actuatable lens element configured to be switched between first and second discrete focal lengths to provide the first and second optical characteristics, respectively.

26. The LIDAR system of claim 23, wherein a first angular resolution of the first field of view is less than a second angular resolution of the second field of view.

27. The LIDAR system of claim 26, further comprising:
at least one control circuit that is configured to switch the at least one optical element between the first and second optical characteristics in first and second imaging modes, respectively, wherein the first imaging mode is configured to image a farther distance range than the second imaging mode.

28. The LIDAR system of claim 23, wherein the LIDAR system is configured to be coupled to a vehicle such that the lidar emitter and lidar detector are oriented relative to an intended direction of travel of the vehicle.
